(19) United States
(12) Patent Application Publication
(10) Pub. No.: US 2006/0257648 A1
(43) Pub. Date: Nov. 16, 2006

(54) Cold-workable laminate

(75) Inventors: Hans-Rudolf Nägeli, Nauhausen (CH); Erwin Pasbrig, Singen (DE)

Correspondence Address: FISHER, CHRISTEN & SABOL, 1725 K STREET, N.W., SUITE 1108, WASHINGTON, DC, 20006, US

(73) Assignee: ALCAN TECHNOLOGY & MANAGEMENT LTD., Neuhausen Am Rheinfall (CH)

(21) Appl. No.: 10/559,800

(22) PCT Filed: Jun. 3, 2004
(86) PCT No.: PCT/EP04/05978

§ 371 Date: Dec. 8, 2005

(30) Foreign Application Priority Data
Jun. 17, 2003 (EP) 03405435.3

(51) Int. Cl. B32B 15/08; B32B 15/20; B32B 15/085; B32B 15/09; B32B 15/088

(52) U.S. Cl. 428/327; 428/457; 428/910; 428/461; 428/458; 428/463; 428/339; 428/341

(57) ABSTRACT

A cold-workable laminate for the production of containers for packaging of pharmaceutical and medical technical products and diagnostic agents has an aluminium film with a biaxially stretched plastic film on one side as an outer layer, and a sealing layer arranged on the second side. The aluminium film is connected with the biaxially stretched plastic film by extrusion laminating or the biaxially stretched plastic film is extrusion-coated with a polyolefin and lacquer-laminated to the aluminium film. The laminate has at least 15% higher cold-working capacity than laminates of the prior art and has improved delamination resistance.

The invention concerns a cold-workable laminate for the production of containers for packaging of pharmaceutical and medical technical products and diagnostic agents, with an aluminium film, a biaxially stretched plastic film arranged on a first side of the aluminium film as an outer layer, and a sealing layer arranged on the second side of the aluminium film.

For the production of containers for packaging of pharmaceutical and medical technical products and diagnostic agents, such as e.g. base parts of blister and push-through packs, cold-workable laminates are known with the structure of biaxially stretched plastic film/aluminium film/sealing layer (lacquer, plastic film, or plastic coating). The external plastic film is connected to the aluminium film by way of an adhesive, where the aluminium film is mainly lacquered to compensate for the influence of the coatings on the aluminium film. It has also been proposed to create the connection between an external film of biaxially stretched polyamide and the aluminium film by hot calendering, where the adhesive or laminating medium has been previously applied and dried.

With the above laminates a maximum workability by cold forming of around 30% can be achieved. The resistance to damp and heat, i.e. the resistance of the external plastic film to delamination, is maximum 26 weeks under ICH conditions.

The invention is based on the object of creating a cold-workable laminate of the type cited initially which in comparison with the laminates according to the prior art allows at least 15% more cold working and has a delamination resistance under ICH conditions of at least 52 weeks.

The object according to the invention is achieved in principle by the following two routes:
1. The aluminium film is connected with the biaxially stretched plastic film of the outer layer by extrusion laminating.
   The biaxially stretched plastic film of the outer layer is preferably of the type PE (polyethylene), PP (polypropylene), PA (polyamide), polyester, PEN (polyethylene naphthalate), COC (cycloolefin-ethylene-copolymer) or PS (polystyrene). The film thickness lies in the range from 10 to 50 μm, preferably 15 to 30 μm.
   Suitable laminating media are adhesion-modified polyolefins, in particular PE-MAH (polyethylene-maleic acid anhydride graft polymer), PP-MAH (polypropylene-maleic acid anhydride graft polymer), EVA (ethylene-vinyl acetate copolymer)-MAH or PE copolymers, in particular EAA (ethylene acrylic acid), EBA (ethylene-butylacrylate), EMA (ethylene-methacrylic acid), EEA (ethylene-ethylacrylate) or ionomers. The thickness of the extrusion lamination lies in the range of 2 to 30 μm, preferably 3 to 12 μm, as a mono-layer or co-extruded e.g. PP-MAH/PP/PP-MAH.
   In a particularly preferred laminate structure the outer layer comprises a biaxially stretched (oriented) polyamide film (oPA film) which is extrusion-laminated with PE-LLD (linear low density)-MAH against the aluminium film.
   The biaxially oriented plastic film and/or the aluminium film can be coated with a primer. Suitable primers are water- or solvent-based polyamide, PP-MAH, EAA or acrylate or similar primers.
2. The biaxially stretched plastic film of the outer layer is extrusion-coated with a polyolefin and lacquer-laminated against the aluminium film. The side of the biaxially stretched plastic film coated with the polyolefin can be directed against the aluminium film or against the outside.
   The biaxially stretched plastic film of the outer layer is preferably of the type PE, PP, polyamide, polyester, PEN, COC or polystyrene and is extrusion-coated with PE or PP. The extrusion coating has an application weight in the range of 5 to 40 g/M², preferably 10 to 30 g/M².

Both routes lead to laminates which meet the requirements with regard to degree of cold-working and delamination resistance.

The thickness of the aluminium films used for laminates according to the invention lies in the range from 20 to 100 μm, preferably 30 to 70 μm. The aluminium film can be soft or have a defined hardness.

The laminates according to the invention can be processed into packaging containers on existing packaging plants.

The inner or sealing layer can be an unstretched plastic film which is lacquer- or extrusion-laminated with the aluminium film. Preferred are plastics based on PVC (polyvinyl chloride), PVDC (polyvinylidene chloride) PE, PP, polyolefin copolymers, in particular EAA, EEA, and ionomers, polyamide, polystyrene, COC, PET, PEN or PCTFE (polychlorotetrafluoroethylene, ACLAR®). The thickness of the plastic film or combination of two or more films lies in the range from 10 to 120 μm, preferably 19 to 100 μm. The extrusion lamination can e.g. be performed with a PE terpolymer. Lacquer lamination can be performed with a watery solvent-based or solvent-free lamination media.

The sealing layer can also be a polyolefin and aluminium foil extrusion-coated with the sealing layer. Preferred sealing layers produced by extrusion coating comprise polyolefin plastics, in particular PE, PP, EAA, EAA-PE-LD or an ionomer, e.g. a sodium or zinc acrylate co- or terionomer, such as SURLYN® with an application weight in the range of 5 to 80 g/M², preferably 15 to 40 g/M², or coated with PVDC with an application weight in the range of 5 to 120 g/M², preferably 20 to 60 g/M².

Extrusion laminated sealing layers or sealing layers produced by extrusion coating are environmentally friendly as they do not require solvents and consequently do not pollute the atmosphere with VOC's.

Further preferred sealing layers are hot sealing layers based on acrylate, polybutylate, morprime, styrene acrylate with polyolefin groups, PVC/AC plus acrylate, PP/butadiene or polyester/butadiene/styrene with an application weight in the range from 2 to 20 g/m², preferably 5 to 15 g/m².

The aluminium film can also be coated with a primer and the sealing layer applied to the primer. Suitable primers are e.g. EAA or polyamide primers.

The plastic used for the sealing layer depends on the structure of the cover films provided for sealing the packaging containers made from the laminates.

Further advantages, features and details of the invention arise from the description below of preferred embodiment examples.

The table below gives a selection of cold-workable laminates constructed according to the invention with biaxially stretched, oriented polyamide (oPA) as an outer layer. The “outside” of packaging containers is the side of the laminate forming the outside, the “inside” is the side facing the plastic of a cover film as a seal, in each case with the application weight for lacquer coating or film thickness for film coating.

| | | Aluminium | |
|---|---|---|---|
| Example | Outside | Film | Inside |
| 1. | oPA, 25 μm, extrusion-laminated | 45 μm | PVC, PP or PE film, lacquer- |
| | with PE-LLD-MAH, 10 μm | | laminated |
| 2. | oPA, 25 μm, extrusion-laminated | 45 μm | PVC, PP or PE film, extrusion- |
| | with PE-LLD-MAH, 10 μm | | laminated |
| 3. | oPA, 25 μm, extrusion-laminated | 45 μm | co-extrusion-coated with EAA/ |
| | with PE-LLD-MAH, 10 μm | | PE-LD |
| 4. | oPA, 25 μm, extrusion-laminated | 45 μm | PVC, PP or PE film, lacquer- |
| | with PE-LLD-MAH, 10 μm, against | | laminated |
| | primer | | |
| 5. | oPA, 25 μm, extrusion-laminated | 45 μm | PVC, PP or PE film, lacquer- |
| | with PP-MAH, 10 μm | | laminated |
| 6. | oPA, 25 μm, extrusion-laminated | 45 μm | PVC, PP or PE film, extrusion- |
| | with PP-MAH, 10 μm | | laminated |
| 7. | oPA, 25 μm, extrusion-laminated | 45 μm | co-extrusion-coated with EAA/ |
| | with PP-MAH, 10 μm | | PE-LD |
| 8. | oPA, 25 μm, extrusion-laminated | 45 μm | PVC, PP or PE film, lacquer- |
| | with EVA-MAH, 10 μm, against | | laminated |
| | primer | | |
| 9. | oPA, 25 μm, extrusion-laminated | 45 μm | PVC, PP or PE film, lacquer- |
| | with EVA-MAH, 10 μm | | laminated |
| 10. | oPA, 25 μm, extrusion-laminated | 45 μm | PVC, PP or PE film, extrusion- |
| | with EVA-MAH, 10 μm | | laminated |
| 11. | oPA, 25 μm, extrusion-laminated | 45 μm | co-extrusion-coated with EAA/ |
| | with EVA-MAH, 10 μm | | PE-LD |
| 12. | oPA, 25 μm, extrusion-laminated | 45 μm | PVC, PP or PE film, lacquer- |
| | with EVA-MAH, 10 μm, against | | laminated |
| | primer | | |
| 13. | oPA, 25 μm/primer, extrusion- | 45 μm | PVC, PP or PE film, lacquer- |
| | laminated with EAA, 10 μm | | laminated |
| 14. | oPA, 25 μm/primer, extrusion- | 45 μm | PVC, PP or PE film, extrusion- |
| | laminated with EAA, 10 μm | | laminated |
| 15. | oPA, 25 μm/primer, extrusion- | 45 μm | co-extrusion-coated with EAA/ |
| | laminated with EAA, 10 μm | | PE-LD |
| 16. | oPA, 25 μm/primer, extrusion- | 45 μm | PVC, PP or PE film, lacquer- |
| | laminated with EAA, 10 μm, against | | laminated |
| | primer | | |
| 17. | oPA, 25 μm/primer, extrusion- | 45 μm | PVC, PP or PE film extrusion- |
| | laminated with EAA, 10 μm, against | | laminated |
| | primer | | |
| 18. | oPA, 25 μm/primer, extrusion- | 45 μm | co-extrusion-coated with EAA/ |
| | laminated with EAA, 10 μm, against | | PE-LD |
| | primer | | |
| 19. | oPA, 25 μm, extrusion-laminated | 45 μm | PVC, PP or PE film, lacquer- |
| | with ionomer, 10 μm | | laminated |
| 20. | oPA, 25 μm, extrusion-laminated | 45 μm | PVC, PP or PE film, extrusion- |
| | with ionomer, 10 μm | | laminated |
| 21. | oPA, 25 μm, extrusion-laminated | 45 μm | co-extrusion-coated with EAA/ |
| | with ionomer, 10 μm | | PE-LD |
| 22. | oPA, 25 μm, extrusion-laminated | 45 μm | PVC, PP or PE film, lacquer- |
| | with ionomer, 10 μm, against primer | | laminated |
| 23. | oPA, 25 μm/primer, extrusion- | 45 μm | PVC, PP or PE film, lacquer- |
| | laminated with ionomer, 10 μm | | laminated |
| 24. | oPA, 25 μm/primer, extrusion- | 45 μm | PVC, PP or PE film, extrusion- |
| | laminated with ionomer, 10 μm | | laminated |
| 25. | oPA, 25 μm/primer, extrusion- | 45 μm | co-extrusion-coated with EAA/ |
| | laminated with ionomer, 10 μm | | PE-LD |
| 26. | oPA, 25 μm/primer, extrusion- | 45 μm | PVC, PP or PE film, lacquer- |
| | laminated with ionomer, 10 μm, | | laminated |
| | against primer | | |
| 27. | oPA, 25 μm, extrusion-laminated | 45 μm | PVC, PP or PE film, lacquer- |
| | with EMA, 10 μm | | laminated |
| 28. | oPA, 25 μm, extrusion-laminated | 45 μm | PVC, PP or PE film, extrusion- |
| | with EMA, 10 μm | | laminated |
| 29. | oPA, 25 μm, extrusion-laminated | 45 μm | co-extrusion-coated with EAA/ |
| | with EMA, 10 μm | | PE-LD |
| 30. | oPA, 25 μm, extrusion-laminated | 45 μm | PVC, PP or PE film, lacquer- |
| | EMA, 10 μm, against primer | | laminated |
| 31. | oPA, 25 μm, extrusion-laminated | 45 μm | PVC, PP or PE film, lacquer- |
| | with EEA, 10 μm | | laminated |
| 32. | oPA, 25 μm, extrusion-laminated | 45 μm | PVC, PP or PE film, extrusion- |
| | with EEA, 10 μm | | laminated |
| 33. | oPA, 25 μm, extrusion-laminated | 45 μm | co-extrusion-coated with EAA/ |
| | with EEA, 10 μm | | PE-LD |
| 34. | oPA, 25 μm, extrusion-laminated | 45 μm | PVC, PPE or PE film, lacquer- |
| | with EEA, 10 μm, against primer | | laminated |
| 35. | oPA, 25 μm, extrusion-coated with | 45 μm | oPA, 25 μm, extrusion-coated |
| | PE, 20 g/m², lacquer-laminated with | | with PE, 20 g/m², lacquer- |
| | solvent-containing laminating | | laminated, PE layer lies against |
| | medium against primer, PE layer | | aluminium film |
| | lies against aluminium film | | |
| 36. | oPA, 25 μm, extrusion-coated with | 45 μm | oPA, 25 μm, extrusion-coated |
| | PE, 20 g/m², lacquer-laminated with | | with PP, 20 g/m², lacquer- |
| | solvent-containing laminating | | laminated against primer, PE |
| | medium against primer, PE layer | | layer lies against aluminium film |
| | lies against aluminium film | | |
| 37. | oPA, 25 μm, extrusion-coated with | 45 μm | oPA, 25 μm, extrusion-coated |
| | PE, 20 g/m², lacquer-laminated with | | with PE, 20 g/m², lacquer- |
| | solvent-containing laminating | | laminated, PE layer lies against |
| | medium, PE layer lies against | | aluminium film |
| | aluminium film | | |
| 38. | oPA, 25 μm, extrusion-coated with | 45 μm | oPA, 25 μm, extrusion-coated |
| | PE, 20 g/m², lacquer-laminated with | | with PP, 20 g/m², lacquer- |
| | solvent-containing laminating | | laminated against primer, PE |
| | medium, PE layer lies against | | layer lies against aluminium film |
| | aluminium film | | |
| 39. | oPA, 25 μm, extrusion-coated with | 60 μm | oPA, 25 μm, extrusion-coated |
| | PE, 20 g/m², lacquer-laminated with | | with PE, 20 g/m², lacquer- |
| | solvent-containing laminating | | laminated, PE layer lies against |
| | medium against primer, PE layer | | aluminium film |
| | lies against aluminium film | | |
| 40. | oPA, 25 μm, extrusion-coated with | 60 μm | oPA, 25 μm, extrusion-coated |
| | PE, 20 g/m², lacquer-laminated with | | with PE, 20 g/m², lacquer- |
| | solvent-containing laminating | | laminated against primer, PE |
| | medium against primer, PE layer | | layer lies against aluminium film |
| | lies against aluminium film | | |
| 41. | oPA, 25 μm, extrusion-coated with | 60 μm | oPA, 25 μm, extrusion-coated |
| | PE, 20 g/m², lacquer-laminated with | | with PE, 20 g/m², lacquer- |
| | solvent-containing laminating | | laminated, PE layer lies against |
| | medium, PE layer lies against | | aluminium film |
| | aluminium film | | |
| 42. | oPA, 25 μm, extrusion-coated with | 60 μm | oPA, 25 μm, extrusion-coated |
| | PE, 20 g/m², lacquer-laminated with | | with PE, 20 g/m², lacquer- |
| | solvent-containing laminating | | laminated against primer, PE |
| | medium, PE layer lies against | | layer lies against aluminium film |
| | aluminium film | | |
| 43. | oPA, 25 μm, extrusion-coated with | 45 μm | oPA, 25 μm, extrusion-coated |
| | PE, 20 g/m², lacquer-laminated with | | with PE, 20 g/m², lacquer- |
| | solvent-containing laminating | | laminated, oPA film lies against |
| | medium against primer, oPA film | | aluminium film |
| | lies against aluminium film | | |
| 44. | oPA, 25 μm, extrusion-coated with | 45 μm | oPA, 25 μm, extrusion-coated |
| | PE, 20 g/m², lacquer-laminated with | | with PE, 20 g/m², lacquer- |
| | solvent-containing laminating | | laminated against primer, oPA |
| | medium against primer, oPA film | | film lies against aluminium film |
| | lies against aluminium film | | |
| 45. | oPA, 25 μm, extrusion-coated with | 45 μm | oPA, 25 μm, extrusion-coated |
| | PE, 20 g/m², lacquer-laminated with | | with PE, 20 g/m², lacquer- |
| | solvent-containing laminating | | laminated, oPA film lies against |
| | medium, oPA film lies against | | aluminium film |
| | aluminium film | | |
| 46. | oPA, 25 μm, extrusion-coated with | 45 μm | oPA, 25 μm, extrusion-coated |
| | PE, 20 g/m², lacquer-laminated with | | with PE, 20 g/m², lacquer- |
| | solvent-containing laminating | | laminated against primer, oPA |
| | medium, oPA film lies against | | film lies against aluminium film |
| | aluminium film | | |
| 47. | oPA, 25 μm, extrusion-coated with | 60 μm | oPA, 25 μm, extrusion-coated |
| | PE, 20 g/m², lacquer-laminated with | | with PE, 20 g/m², lacquer- |
| | solvent-containing laminating | | laminated, oPA film lies against |
| | medium against primer, oPA film | | aluminium film |
| | lies against aluminium film | | |
| 48. | oPA, 25 μm, extrusion-coated with | 45 μm | oPA, 25 μm, extrusion-coated |
| | PE, 20 g/m², lacquer-laminated with | | with PE, 20 g/m², lacquer- |
| | solvent-containing laminating | | laminated against primer, oPA |
| | medium against primer, oPA film | | film lies against aluminium film |
| | lies against aluminium film | | |
| 49. | oPA, 25 μm, extrusion-coated with | 45 μm | oPA, 25 μm, extrusion-coated |
| | PE, 20 g/m², lacquer-laminated with | | with PE, 20 g/m², lacquer- |
| | solvent-containing laminating | | laminated, oPA film lies against |
| | medium against primer, oPA film | | aluminium film |
| | lies against aluminium film | | |
| 50. | oPA, 25 μm, extrusion-coated with | 45 μm | oPA, 25 μm, extrusion-coated |
| | PE, 20 g/m², lacquer-laminated with | | with PE, 20 g/m², lacquer- |
| | solvent-containing laminating | | laminated against primer, oPA |
| | medium, oPA film lies against | | film lies against aluminium film |
| | aluminium film | | |
| 51. | oPA, 25 μm, extrusion-coated with | 45 μm | oPA, 25 μm, extrusion-coated |
| | PP, 20 g/m², lacquer-laminated with | | with PP, 20 g/m², lacquer- |
| | solvent-containing laminating | | laminated, PP layer lies against |
| | medium against primer, PP layer | | aluminium film |
| | lies against aluminium film | | |
| 52. | oPA, 25 μm, extrusion-coated with | 45 μm | oPA, 25 μm, extrusion-coated |
| | PP, 20 g/m², lacquer-laminated with | | with PP, 20 g/m², lacquer- |
| | solvent-containing laminating | | laminated against primer, PP |
| | medium against primer, PP layer | | layer lies against aluminium film |
| | lies against aluminium film | | |
| 53. | oPA, 25 μm, extrusion-coated with | 45 μm | oPA, 25 μm, extrusion-coated |
| | PP, 20 g/m², lacquer-laminated with | | with PP, 20 g/m², lacquer- |
| | solvent-containing laminating | | laminated, PP layer lies against |
| | medium, PP layer lies against | | aluminium film |
| | aluminium film | | |
| 54. | oPA, 25 μm, extrusion-coated with | 45 μm | oPA, 25 μm, extrusion-coated |
| | PP, 20 g/m², lacquer-laminated with | | with PP, 20 g/m², lacquer- |
| | solvent-containing laminating | | laminated against primer, PP |
| | medium, PP layer lies against | | layer lies against aluminium film |
| | aluminium film | | |
| 55. | oPA, 25 μm, extrusion-coated with | 60 μm | oPA, 25 μm, extrusion-coated |
| | PP, 20 g/m², lacquer-laminated with | | with PP, 20 g/m², lacquer- |
| | solvent-containing laminating | | laminated, PP layer lies against |
| | medium against primer, PP layer | | aluminium film |
| | lies against aluminium film | | |
| 56. | oPA, 25 μm, extrusion-coated with | 60 μm | oPA, 25 μm, extrusion-coated |
| | PP, 20 g/m², lacquer-laminated with | | with PP, 20 g/m², lacquer- |
| | solvent-containing laminating | | laminated against primer, PP |
| | medium against primer, PP layer | | layer lies against aluminium film |
| | lies against aluminium film | | |
| 57. | oPA, 25 μm, extrusion-coated with | 60 μm | oPA, 25 μm, extrusion-coated |
| | PP, 20 g/m², lacquer-laminated with | | with PP, 20 g/m², lacquer- |
| | solvent-containing laminating | | laminated, PP layer lies against |
| | medium, PP layer lies against | | aluminium film |
| | aluminium film | | |
| 58. | oPA, 25 μm, extrusion-coated with | 60 μm | oPA, 25 μm, extrusion-coated |
| | PP, 20 g/m², lacquer-laminated with | | with PP, 20 g/m², lacquer- |
| | solvent-containing laminating | | laminated against primer, PP |
| | medium, PP layer lies against | | layer lies against aluminium film |
| | aluminium film | | |
| 59. | oPA, 25 μm, extrusion-coated with | 45 μm | oPA, 25 μm, extrusion-coated |
| | PP, 20 g/m², lacquer-laminated with | | with PP, 20 g/m², lacquer- |
| | solvent-containing laminating | | laminated, oPA film lies against |
| | medium against primer, oPA film | | aluminium film |
| | lies against aluminium film | | |
| 60. | oPA, 25 μm, extrusion-coated with | 45 μm | oPA, 25 μm, extrusion-coated |
| | PP, 20 g/m², lacquer-laminated with | | with PP, 20 g/m², lacquer- |
| | solvent-containing laminating | | laminated against primer, oPA |
| | medium against primer, oPA film | | film lies against aluminium film |
| | lies against aluminium film | | |
| 61. | oPA, 25 μm, extrusion-coated with | 45 μm | oPA, 25 μm, extrusion-coated |
| | PP, 20 g/m², lacquer-laminated with | | with PP, 20 g/m², lacquer- |
| | solvent-containing laminating | | laminated, oPA film lies against |
| | medium, oPA film lies against | | aluminium film |
| | aluminium film | | |
| 62. | oPA, 25 μm, extrusion-coated with | 45 μm | oPA, 25 μm, extrusion-coated |
| | PP, 20 g/m², lacquer-laminated with | | with PP, 20 g/m², lacquer- |
| | solvent-containing laminating | | laminated against primer, oPA |
| | medium, oPA film lies against | | film lies against aluminium film |
| | aluminium film | | |
| 63. | oPA, 25 μm, extrusion-coated with | 60 μm | oPA, 25 μm, extrusion-coated |
| | PP, 20 g/m², lacquer-laminated with | | with PP, 20 g/m², lacquer- |
| | solvent-containing laminating | | laminated, oPA film lies against |
| | medium against primer, oPA film | | aluminium film |
| | lies against aluminium film | | |
| 64. | oPA, 25 μm, extrusion-coated with | 45 μm | oPA, 25 μm, extrusion-coated |
| | PP, 20 g/m², lacquer-laminated with | | with PP, 20 g/m², lacquer- |
| | solvent-containing laminating | | laminated against primer, oPA |
| | medium against primer, oPA film | | film lies against aluminium film |
| | lies against aluminium film | | |
| 65. | oPA, 25 μm, extrusion-coated with | 45 μm | oPA, 25 μm, extrusion-coated |
| | PP, 20 g/m², lacquer-laminated with | | with PP, 20 g/m², lacquer- |
| | solvent-containing laminating | | laminated, oPA film lies against |
| | medium, oPA film lies against | | aluminium film |
| | aluminium film | | |
| 66. | oPA, 25 μm, extrusion-coated with | 45 μm | oPA, 25 μm, extrusion-coated |
| | PP, 20 g/m², lacquer-laminated with | | with PP, 20 g/m², lacquer- |
| | solvent-containing laminating | | laminated against primer, oPA |
| | medium, oPA film lies against | | film lies against aluminium film |
| | aluminium film | | |
| 67. | oPA, 25 μm, extrusion-coated with | 45 μm | oPA, 25 μm, extrusion-coated |
| | PP, 20 g/m², lacquer-laminated with | | with PP, 20 g/m², lacquer- |
| | solvent-containing laminating | | laminated, PP layer lies against |
| | medium against primer, PP layer | | aluminium film |
| | lies against aluminium film | | |
| 68. | oPA, 25 μm, extrusion-coated with | 45 μm | oPA, 25 μm, extrusion-coated |
| | PP, 20 g/m², lacquer-laminated with | | with PP, 20 g/m², lacquer- |
| | solvent-containing laminating | | laminated, PP layer lies against |
| | medium against primer, PP layer | | aluminium film |
| | lies against aluminium film | | |
| 69. | oPA, 25 μm, extrusion-coated with | 45 μm | oPA, 25 μm, extrusion-coated |
| | PP, 20 g/m², lacquer-laminated with | | with PP, 20 g/m², lacquer- |
| | solvent-containing laminating | | laminated, PP layer lies against |
| | medium, PP layer lies against | | aluminium film |
| | aluminium film | | |
| 70. | oPA, 25 μm, extrusion-coated with | 45 μm | oPA, 25 μm, extrusion-coated |
| | PP, 20 g/m², lacquer-laminated with | | with PP, 20 g/m², lacquer- |
| | solvent-containing laminating | | laminated against primer, PP |
| | medium, PP layer lies against | | layer lies against aluminium film |
| | aluminium film | | |
| 71. | oPA, 25 μm, extrusion-coated with | 60 μm | oPA, 25 μm, extrusion-coated |
| | PP, 20 g/m², lacquer-laminated with | | with PP, 20 g/m², lacquer- |
| | solvent-containing laminating | | laminated, PP layer lies against |
| | medium against primer, PP layer | | aluminium film |
| | lies against aluminium film | | |
| 72. | oPA, 25 μm, extrusion-coated with | 60 μm | oPA, 25 μm, extrusion-coated |
| | PP, 20 g/m², lacquer-laminated with | | with PP, 20 g/m², lacquer- |
| | solvent-containing laminating | | laminated against primer, PP |
| | medium against primer, PP layer | | layer lies against aluminium film |
| | lies against aluminium film | | |
| 73. | oPA, 25 μm, extrusion-coated with | 60 μm | oPA, 25 μm, extrusion-coated |
| | PP, 20 g/m², lacquer-laminated with | | with PP, 20 g/m², lacquer- |
| | solvent-containing laminating | | laminated, PP layer lies against |
| | medium, PP layer lies against | | aluminium film |
| | aluminium film | | |
| 74. | oPA, 25 μm, extrusion-coated with | 60 μm | oPA, 25 μm, extrusion-coated |
| | PP, 20 g/m², lacquer-laminated with | | with PP, 20 g/m², lacquer- |
| | solvent-containing laminating | | laminated against primer, PP |
| | medium, PP layer lies against | | layer lies against aluminium film |
| | aluminium film | | |
| 75. | oPA, 25 μm, extrusion-coated with | 45 μm | oPA, 25 μm, extrusion-coated |
| | PP, 20 g/m², lacquer-laminated with | | with PP, 20 g/m², lacquer- |
| | solvent-containing laminating | | laminated, oPA film lies against |
| | medium against primer, oPA film | | aluminium film |
| | lies against aluminium film | | |
| 76. | oPA, 25 μm, extrusion-coated with | 45 μm | oPA, 25 μm, extrusion-coated |
| | PP, 20 g/m², lacquer-laminated with | | with PP, 20 g/m², lacquer- |
| | solvent-containing laminating | | laminated against primer, oPA |
| | medium against primer, oPA film | | film lies against aluminium film |
| | lies against aluminium film | | |
| 77. | oPA, 25 μm, extrusion-coated with | 45 μm | oPA, 25 μm, extrusion-coated |
| | PP, 20 g/m², lacquer-laminated with | | with PP, 20 g/m², lacquer- |
| | solvent-containing laminating | | laminated, oPA film lies against |
| | medium, oPA film lies against | | aluminium film |
| | aluminium film | | |
| 78. | oPA, 25 μm, extrusion-coated with | 45 μm | oPA, 25 μm, extrusion-coated |
| | PP, 20 g/m², lacquer-laminated with | | with PP, 20 g/m², lacquer- |
| | solvent-containing laminating | | laminated, oPA film lies against |
| | medium, oPA film lies against | | aluminium film |
| | aluminium film | | |
| 79. | oPA, 25 μm, extrusion-coated with | 60 μm | oPA, 25 μm, extrusion-coated |
| | PP, 20 g/m², lacquer-laminated with | | with PP, 20 g/m², lacquer- |
| | solvent-containing laminating | | laminated, oPA film lies against |
| | medium against primer, oPA film | | aluminium film |
| | lies against aluminium film | | |
| 80. | oPA, 25 μm, extrusion-coated with | 45 μm | oPA, 25 μm, extrusion-coated |
| | PP, 20 g/m², lacquer-laminated with | | with PP, 20 g/m², lacquer- |
| | solvent-containing laminating | | laminated against primer2, oPA |
| | medium against primer, oPA film | | film lies against aluminium film |
| | lies against aluminium film | | |
| 81. | oPA, 25 μm, extrusion-coated with | 45 μm | oPA, 25 μm, extrusion-coated |
| | PP, 20 g/m², lacquer-laminated with | | with PP, 20 g/m², lacquer- |
| | solvent-containing laminating | | laminated, oPA film lies against |
| | medium, oPA film lies against | | aluminium film |
| | aluminium film | | |
| 82. | oPA, 25 μm, extrusion-coated with | 45 μm | oPA, 25 μm, extrusion-coated |
| | PP, 20 g/m², lacquer-laminated with | | with PP, 20 g/m², lacquer- |
| | solvent-containing laminating | | laminated against primer, oPA |
| | medium, oPA film lies against | | film lies against aluminium film |
| | aluminium film | | |
| 83. | oPA, 25 μm, extrusion-coated with | 45 μm | PVC film, 60 μm, lacquer- |
| | PE, 20 g/m², lacquer-laminated with | | laminated |
| | solvent-containing laminating | | |
| | medium against primer, PE layer | | |
| | lies against aluminium film | | |
| 84. | oPA, 25 μm, extrusion-coated with | 45 μm | PVC film, 30 μm, lacquer- |
| | PE, 20 g/m², lacquer-laminated with | | laminated |
| | solvent-containing laminating | | |
| | medium against primer, PE layer | | |
| | lies against aluminium film | | |
| 85. | oPA, 25 μm, extrusion-coated with | 45 μm | PP film, 60 μm, lacquer-laminated |
| | PE, 20 g/m², lacquer-laminated with | | |
| | solvent-containing laminating | | |
| | medium against primer, PE layer | | |
| | lies against aluminium film | | |
| 86. | oPA, 25 μm, extrusion-coated with | 60 μm | PP film, 60 μm, lacquer-laminated |
| | PE, 20 g/m², lacquer-laminated with | | |
| | solvent-containing laminating | | |
| | medium against primer, PE layer | | |
| | lies against aluminium film | | |
| 87. | oPA, 25 μm, extrusion-coated with | 45 μm | PE film, 60 μm, lacquer-laminated |
| | PE, 20 g/m², lacquer-laminated with | | |
| | solvent-containing laminating | | |
| | medium against primer, PE layer | | |
| | lies against aluminium film | | |
| 88. | oPA, 25 μm, extrusion-coated with | 60 μm | PE film, 60 μm, lacquer-laminated |
| | PE, 20 g/m², lacquer-laminated with | | |
| | solvent-containing laminating | | |
| | medium against primer, PE layer | | |
| | lies against aluminium film | | |
| 89. | oPA, 25 μm, extrusion-coated with | 45 μm | PVC film, 100 μm, lacquer- |
| | PE, 20 g/m², lacquer-laminated with | | laminated |
| | solvent-containing laminating | | |
| | medium against primer, PE layer | | |
| | lies against aluminium film | | |
| 90. | oPA, 25 μm, extrusion-coated with | 45 μm | COC film, 20 μm, lacquer- |
| | PE, 20 g/m², lacquer-laminated with | | laminated |
| | solvent-containing laminating | | |
| | medium against primer, PE layer | | |
| | lies against aluminium film | | |
| 91. | oPA, 25 μm, extrusion-coated with | 60 μm | COC film, 20 μm, lacquer- |
| | PE, 20 g/m², lacquer-laminated with | | laminated |
| | solvent-containing laminating | | |
| | medium against primer, PE layer | | |
| | lies against aluminium film | | |
| 92. | oPA, 25 μm, extrusion-coated with | 45 μm | ACLAR ® film, 23 μm, lacquer- |
| | PE, 20 g/m², lacquer-laminated with | | laminated |
| | solvent-containing laminating | | |
| | medium against primer, PE layer | | |
| | lies against aluminium film | | |
| 93. | oPA, 25 μm, extrusion-coated with | 45 μm | ACLAR ® film, 15 μm, lacquer- |
| | PE, 20 g/m², lacquer-laminated with | | laminated |
| | solvent-containing laminating | | |
| | medium against primer, PE layer | | |
| | lies against aluminium film | | |
| 94. | oPA, 25 μm, extrusion-coated with | 45 μm | Extrusion-coated with SURLYN ®, |
| | PE, 20 g/m², lacquer-laminated with | | 20 g/m² |
| | solvent-containing laminating | | |
| | medium against primer, PE layer | | |
| | lies against aluminium film | | |
| 95. | oPA, 25 μm, extrusion-coated with | 45 μm | Extrusion-coated with PE, 20 g/m² |
| | PE, 20 g/m², lacquer-laminated with | | |
| | solvent-containing laminating | | |
| | medium against primer, PE layer | | |
| | lies against aluminium film | | |
| 96. | oPA, 25 μm, extrusion-coated with | 45 μm | PVC film, 60 μm, lacquer- |
| | PE, 20 g/m², lacquer-laminated with | | laminated |
| | solvent-containing laminating | | |
| | medium against primer, oPA layer | | |
| | lies against aluminium film | | |
| 97. | oPA, 25 μm, extrusion-coated with | 45 μm | PVC film, 30 μm, lacquer- |
| | PE, 20 g/m², lacquer-laminated with | | laminated |
| | solvent-containing laminating | | |
| | medium against primer, oPA layer | | |
| | lies against aluminium film | | |
| 98. | oPA, 25 μm, extrusion-coated with | 45 μm | PP film, 60 μm, lacquer-laminated |
| | PE, 20 g/m², lacquer-laminated with | | |
| | solvent-containing laminating | | |
| | medium against primer, oPA layer | | |
| | lies against aluminium film | | |
| 99. | oPA, 25 μm, extrusion-coated with | 60 μm | PP film, 60 μm, lacquer-laminated |
| | PE, 20 g/m², lacquer-laminated with | | |
| | solvent-containing laminating | | |
| | medium against primer, oPA layer | | |
| | lies against aluminium film | | |
| 100. | oPA, 25 μm, extrusion-coated with | 45 μm | PE film, 60 μm, lacquer-laminated |
| | PE, 20 g/m², lacquer-laminated with | | |
| | solvent-containing laminating | | |
| | medium against primer, oPA layer | | |
| | lies against aluminium film | | |
| 101. | oPA, 25 μm, extrusion-coated with | 60 μm | PE film, 60 μm, lacquer-laminated |
| | PE, 20 g/m², lacquer-laminated with | | |
| | solvent-containing laminating | | |
| | medium against primer, oPA layer | | |
| | lies against aluminium film | | |
| 102. | oPA, 25 μm, extrusion-coated with | 45 μm | PVC film, 100 μm, lacquer- |
| | PE, 20 g/m², lacquer-laminated with | | laminated |
| | solvent-containing laminating | | |
| | medium against primer, oPA layer | | |
| | lies against aluminium film | | |
| 103. | oPA, 25 μm, extrusion-coated with | 45 μm | COC film, 20 μm, lacquer- |
| | PE, 20 g/m², lacquer-laminated with | | laminated |
| | solvent-containing laminating | | |
| | medium against primer, oPA layer | | |
| | lies against aluminium film | | |
| 104. | oPA, 25 μm, extrusion-coated with | 60 μm | COC film, 20 μm, lacquer- |
| | PE, 20 g/m², lacquer-laminated with | | laminated |
| | solvent-containing laminating | | |
| | medium against primer, oPA layer | | |
| | lies against aluminium film | | |
| 105. | oPA, 25 μm, extrusion-coated with | 45 μm | ACLAR ® film, 23 μm, lacquer- |
| | PE, 20 g/m², lacquer-laminated with | | laminated |
| | solvent-containing laminating | | |
| | medium against primer, oPA layer | | |
| | lies against aluminium film | | |
| 106. | oPA, 25 μm, extrusion-coated with | 45 μm | ACLAR ® film, 15 μm, lacquer- |
| | PE, 20 g/m², lacquer-laminated with | | laminated |
| | solvent-containing laminating | | |
| | medium against primer, oPA layer | | |
| | lies against aluminium film | | |
| 107. | oPA, 25 μm, extrusion-coated with | 45 μm | Extrusion-coated with SURLYN ®, |
| | PE, 20 g/m², lacquer-laminated with | | 20 g/m² |
| | solvent-containing laminating | | |
| | medium against primer, oPA layer | | |
| | lies against aluminium film | | |
| 108. | oPA, 25 μm, extrusion-coated with | 45 μm | Extrusion-coated with PE, 20 g/m² |
| | PE, 20 g/m², lacquer-laminated with | | |
| | solvent-containing laminating | | |
| | medium against primer, oPA layer | | |
| | lies against aluminium film | | |
| 109. | oPA, 25 μm, extrusion-coated with | 45 μm | PVC film, 60 μm, lacquer- |
| | PP, 20 g/m², lacquer-laminated with | | laminated |
| | solvent-containing laminating | | |
| | medium against primer, PP layer | | |
| | lies against aluminium film | | |
| 110. | oPA, 25 μm, extrusion-coated with | 45 μm | PVC film, 30 μm, lacquer- |
| | PP, 20 g/m², lacquer-laminated with | | laminated |
| | solvent-containing laminating | | |
| | medium against primer, PP layer | | |
| | lies against aluminium film | | |
| 111. | oPA, 25 μm, extrusion-coated with | 45 μm | PP film, 60 μm, lacquer-laminated |
| | PP, 20 g/m², lacquer-laminated with | | |
| | solvent-containing laminating | | |
| | medium against primer, PP layer | | |
| | lies against aluminium film | | |
| 112. | oPA, 25 μm, extrusion-coated with | 60 μm | PP film, 60 μm, lacquer-laminated |
| | PP, 20 g/m², lacquer-laminated with | | |
| | solvent-containing laminating | | |
| | medium against primer, PP layer | | |
| | lies against aluminium film | | |
| 113. | oPA, 25 μm, extrusion-coated with | 45 μm | PE film, 60 μm, lacquer-laminated |
| | PP, 20 g/m², lacquer-laminated with | | |
| | solvent-containing laminating | | |
| | medium against primer, PP layer | | |
| | lies against aluminium film | | |
| 114. | oPA, 25 μm, extrusion-coated with | 60 μm | PE film, 60 μm, lacquer-laminated |
| | PP, 20 g/m², lacquer-laminated with | | |
| | solvent-containing laminating | | |
| | medium against primer, PP layer | | |
| | lies against aluminium film | | |
| 115. | oPA, 25 μm, extrusion-coated with | 45 μm | PVC film, 100 μm, lacquer- |
| | PP, 20 g/m², lacquer-laminated with | | laminated |
| | solvent-containing laminating | | |
| | medium against primer, PP layer | | |
| | lies against aluminium film | | |
| 116. | oPA, 25 μm, extrusion-coated with | 45 μm | COC film, 20 μm, lacquer- |
| | PP, 20 g/m², lacquer-laminated with | | laminated |
| | solvent-containing laminating | | |
| | medium against primer, PP layer | | |
| | lies against aluminium film | | |
| 117. | oPA, 25 μm, extrusion-coated with | 60 μm | COC film, 20 μm, lacquer- |
| | PP, 20 g/m², lacquer-laminated with | | laminated |
| | solvent-containing laminating | | |
| | medium against primer, PP layer | | |
| | lies against aluminium film | | |
| 118. | oPA, 25 μm, extrusion-coated with | 45 μm | ACLAR ® film, 23 μm, lacquer- |
| | PP, 20 g/m², lacquer-laminated with | | laminated |
| | solvent-containing laminating | | |
| | medium against primer, PP layer | | |
| | lies against aluminium film | | |
| 119. | oPA, 25 μm, extrusion-coated with | 45 μm | ACLAR ® film, 15 μm, lacquer- |
| | PP, 20 g/m², lacquer-laminated with | | laminated |
| | solvent-containing laminating | | |
| | medium against primer, PP layer | | |
| | lies against aluminium film | | |
| 120. | oPA, 25 μm, extrusion-coated with | 45 μm | Extrusion-coated with SURLYN ®, |
| | PP, 20 g/m², lacquer-laminated with | | 20 g/m² |
| | solvent-containing laminating | | |
| | medium against primer, PP layer | | |
| | lies against aluminium film | | |
| 121. | oPA, 25 μm, extrusion-coated with | 45 μm | Extrusion-coated with PE, 20 g/m² |
| | PP, 20 g/m², lacquer-laminated with | | |
| | solvent-containing laminating | | |
| | medium against primer, PP layer | | |
| | lies against aluminium film | | |
| 122. | oPA, 25 μm, extrusion-coated with | 45 μm | PVC film, 60 μm, lacquer- |
| | PP, 20 g/m², lacquer-laminated with | | laminated |
| | solvent-containing laminating | | |
| | medium against primer, oPA layer | | |
| | lies against aluminium film | | |
| 123. | oPA, 25 μm, extrusion-coated with | 45 μm | PVC film, 30 μm, lacquer- |
| | PP, 20 g/m², lacquer-laminated with | | laminated |
| | solvent-containing laminating | | |
| | medium against primer, oPA layer | | |
| | lies against aluminium film | | |
| 124. | oPA, 25 μm, extrusion-coated with | 45 μm | PP film, 60 μm, lacquer-laminated |
| | PP, 20 g/m², lacquer-laminated with | | |
| | solvent-containing laminating | | |
| | medium against primer, oPA layer | | |
| | lies against aluminium film | | |
| 125. | oPA, 25 μm, extrusion-coated with | 60 μm | PP film, 60 μm, lacquer-laminated |
| | PP, 20 g/m², lacquer-laminated with | | |
| | solvent-containing laminating | | |
| | medium against primer, oPA layer | | |
| | lies against aluminium film | | |
| 126. | oPA, 25 μm, extrusion-coated with | 45 μm | PE film, 60 μm, lacquer-laminated |
| | PP, 20 g/m², lacquer-laminated with | | |
| | solvent-containing laminating | | |
| | medium against primer, oPA layer | | |
| | lies against aluminium film | | |
| 127. | oPA, 25 μm, extrusion-coated with | 60 μm | PE film, 60 μm, lacquer-laminated |
| | PP, 20 g/m², lacquer-laminated with | | |
| | solvent-containing laminating | | |
| | medium against primer, oPA layer | | |
| | lies against aluminium film | | |
| 128. | oPA, 25 μm, extrusion-coated with | 45 μm | PVC film, 100 μm, lacquer- |
| | PP, 20 g/m², lacquer-laminated with | | laminated |
| | solvent-containing laminating | | |
| | medium against primer, oPA layer | | |
| | lies against aluminium film | | |
| 129. | oPA, 25 μm, extrusion-coated with | 45 μm | COC film, 20 μm, lacquer- |
| | PP, 20 g/m², lacquer-laminated with | | laminated |
| | solvent-containing laminating | | |
| | medium against primer, oPA layer | | |
| | lies against aluminium film | | |
| 130. | oPA, 25 μm, extrusion-coated with | 60 μm | COC film, 20 μm, lacquer- |
| | PP, 20 g/m², lacquer-laminated with | | laminated |
| | solvent-containing laminating | | |
| | medium against primer, oPA layer | | |
| | lies against aluminium film | | |
| 131. | oPA, 25 μm, extrusion-coated with | 45 μm | ACLAR ® film, 23 μm, lacquer- |
| | PP, 20 g/m², lacquer-laminated with | | laminated |
| | solvent-containing laminating | | |
| | medium against primer, oPA layer | | |
| | lies against aluminium film | | |
| 132. | oPA, 25 μm, extrusion-coated with | 45 μm | ACLAR ® film, 15 μm, lacquer- |
| | PP, 20 g/m², lacquer-laminated with | | laminated |
| | solvent-containing laminating | | |
| | medium against primer, oPA layer | | |
| | lies against aluminium film | | |
| 133. | oPA, 25 μm, extrusion-coated with | 45 μm | Extrusion-coated with SURLYN ®, |
| | PP, 20 g/m², lacquer-laminated with | | 20 g/m² |
| | solvent-containing laminating | | |
| | medium against primer, oPA layer | | |
| | lies against aluminium film | | |
| 134. | oPA, 25 μm, extrusion-coated with | 45 μm | Extrusion-coated with PE, 20 g/m² |
| | PP, 20 g/m², lacquer-laminated with | | |
| | solvent-containing laminating | | |
| | medium against primer, oPA layer | | |
| | lies against aluminium film | | |
| 135. | oPA, 25 μm, extrusion-coated with | 50 μm | PE film, 40 μm, lacquer-laminated |
| | PP, 20 g/m², lacquer-laminated with | | |
| | solvent-containing laminating | | |
| | medium against primer, oPA layer | | |
| | lies against aluminium film | | |
| 136. | oPA, 25 μm, extrusion-coated with | 45 μm | PVDC film, 19 μm, lacquer- |
| | PP, 20 g/m², lacquer-laminated with | | laminated |
| | solvent-containing laminating | | |
| | medium against primer, oPA layer | | |
| | lies against aluminium film | | |
| 137. | oPA, 25 μm, extrusion-coated with | 60 μm | PVDC film, 19 μm, lacquer- |
| | PP, 20 g/m², lacquer-laminated with | | laminated |
| | solvent-containing laminating | | |
| | medium against primer, oPA layer | | |
| | lies against aluminium film | | |
| 138. | oPA, 25 μm, extrusion-coated with | 45 μm | Lacquered with PVC/AC plus |
| | PP, 20 g/m², lacquer-laminated with | | acrylate, 10 g/m² |
| | solvent-containing laminating | | |
| | medium against primer, oPA layer | | |
| | lies against aluminium film | | |
| 139. | oPA, 25 μm, extrusion-coated with | 60 μm | Lacquered with PVC/AC plus |
| | PP, 20 g/m², lacquer-laminated with | | acrylate, 10 g/m² |
| | solvent-containing laminating | | |
| | medium against primer, oPA layer | | |
| | lies against aluminium film | | |
| 140. | oPA, 25 μm, extrusion-coated with | 45 μm | Lacquered with PP/butadiene, 7 g/m² |
| | PP, 20 g/m², lacquer-laminated with | | |
| | solvent-containing laminating | | |
| | medium against primer, oPA layer | | |
| | lies against aluminium film | | |
| 141. | oPA, 25 μm, extrusion-coated with | 60 μm | Lacquered with PP/butadiene, 7 g/m² |
| | PP, 20 g/m², lacquer-laminated with | | |
| | solvent-containing laminating | | |
| | medium against primer, oPA layer | | |
| | lies against aluminium film | | |
| 142. | oPA, 25 μm, extrusion-coated with | 45 μm | Lacquered with polyester/ |
| | PP, 20 g/m², lacquer-laminated with | | butadiene/styrene, 7 g/m² |
| | solvent-containing laminating | | |
| | medium against primer, oPA layer | | |
| | lies against aluminium film | | |
| 143. | oPA, 25 μm, extrusion-coated with | 60 μm | Lacquered with polyester/ |
| | PP, 20 g/m², lacquer-laminated with | | butadiene/styrene, 7 g/m² |
| | solvent-containing laminating | | |
| | medium against primer, oPA layer | | |
| | lies against aluminium film | | |

The examples above constitute a selection of preferred laminates. The invention is not limited to the examples given.

1. Cold-workable laminate for the production of containers for packaging of pharmaceutical and medical technical products and diagnostic agents, with an aluminum film, a biaxially stretched plastic film arranged on a first side of the aluminum film as an outer layer, and a sealing layer arranged on the second side of the aluminum film, characterized in that the aluminum film is connected with the biaxially stretched plastic film by extrusion laminating.

2. Cold-workable laminate for the production of containers for packaging of pharmaceutical and medical technical products and diagnostic agents, with an aluminum film, a biaxially stretched plastic film arranged on a first side of the aluminum film as an outer layer and a sealing layer arranged on the second side of the aluminum film, characterized in that the biaxially stretched plastic film is extrusion-coated with a polyolefin and lacquer-laminated against the aluminum film.

3. Cold-workable laminate according to claim 1 characterized in that the sealing layer is an unstretched plastic film and is lacquer- or extrusion-laminated with the aluminum film.

4. Cold-workable laminate according to claim 1 characterized in that the sealing layer is a polyolefin and the aluminum film is extrusion-coated with the sealing layer.

5. Cold-workable laminate according to claim 1 characterized in that the sealing layer is a hot sealing lacquer.

6. Cold-workable laminate according to claim 1, characterized in that the biaxially stretched plastic film of the outer layer is of the type PE, PP, polyamide, polyester, PEN, COC or polystyrene and is extrusion-laminated against the aluminum film with adhesion-modified polyolefins in particular PE-MAH, PP-MAH, EVA-MAH or polyethylene co-polymers, in particular EAA, EMA, EEA or ionomers.

7. Cold-workable laminate according to claim 6, characterized in that the thickness of the biaxially stretched plastic film is 10 to 50 μm, preferably 15 to 30 μm.

8. Cold-workable laminate according to claim 6, characterized in that the aluminum film is coated with a primer.

9. Cold-workable laminate according to claim 2, characterized in that the biaxially stretched plastic film of the outer layer is of the type PE, PP, polyamide, polyester, PEN, COC or polystyrene and is extrusion-coated with PE or PP.

10. Cold-workable laminate according to claim 9, characterized in that the application weight of the extrusion coating is 5 to 40 g/m², preferably 15 to 30 g/m².

11. Cold-workable laminate according to claim 3, characterized in that the sealing layer is an unstretched plastic film based on PVC, PVDC, PE, PP, polyolefin copolymers, in particular EAA, EEA, and ionomers, polyamide, polystyrene, COC, PET, PEN or PCTFE.

12. Cold-workable laminate according to claim 11, characterized in that the thickness of the sealing layer is 10 to 120 μm, preferably 19 to 100 μm.

13. Cold-workable laminate according to claim 4, characterized in that the sealing layer is PE, PP, EAA or an ionomer.

14. Cold-workable laminate according to claim 5, characterized in that the sealing layer is a hot sealing lacquer based on acrylate, polybutylate, morprime, styrene acrylate with polyolefin groups, PVC/AC plus acrylate, PP/butadiene or polyester/butadiene/styrene.

15. Cold-workable laminate according to claim 14, characterized in that the application weight of the hot sealing lacquer is 2 to 20 g/m², preferably 5 to 15 g/m².

16. Cold-workable laminate according to claim 11 characterized in that the aluminum film is coated with a primer and the sealing layer is applied to the primer.

17. Cold-workable laminate according to claim 2, characterized in that the sealing layer is an unstretched plastic film and is lacquer- or extrusion-laminated with the aluminum film.

18. Cold-workable laminate according to claim 2, characterized in that the sealing layer is a polyolefin and the aluminum film is extrusion-coated with the sealing layer.

19. Cold-workable laminate according to claim 2, characterized in that the sealing layer is a hot sealing lacquer.

20. Cold-workable laminate according to claim 12, characterized in that the aluminum film is coated with a primer and the sealing layer is applied to the primer.

21. Cold-workable laminate according to claim 13, characterized in that the aluminum film is coated with a primer and the sealing layer is applied to the primer.

22. Cold-workable laminate according to claim 14, characterized in that the aluminum film is coated with a primer and the sealing layer is applied to the primer.

23. Cold-workable laminate according to claim 15, characterized in that aluminum film is coated with a primer and the sealing layer is applied to the primer.
